(19) United States
(12) Patent Application Publication
(10) Pub. No.: US 2004/0210441 A1
(43) Pub. Date: Oct. 21, 2004

(54) Securable recording unit

(76) Inventor: Aaron D. Clark, Reynoldsburg, OH (US)

Correspondence Address: STANDLEY LAW GROUP LLP, 495 METRO PLACE SOUTH, SUITE 210, DUBLIN, OH, 43017, US

(21) Appl. No.: 10/414,831

(22) Filed: Apr. 16, 2003

(51) Int. Cl. G10L 11/00

(52) U.S. Cl. 704/272

(57) ABSTRACT

The present invention is a securable recording unit. The securable recording unit may be adapted to be attached to a book by means of complementary receiving units and receptacles. The securable recording unit of the present invention includes an audio input means for receiving audible sounds (such as, but not limited to, speaking, music, surf, water sounds or wind), an audio output means for playing back the audible sounds, and a storage unit for storing the received audible sounds.

### BACKGROUND AND SUMMARY OF THE INVENTION

The present invention relates a securable recording unit. The securable recording unit may be adapted to be securably attached to another item such as a book. Although the present invention will be primarily described with regard to a book, the securable recording unit may be adapted to be securably attached to other items including, but not limited to, a scrapbook, a catalog, a photo album, a display, a wall, or any other place where it is desirable to have a recording unit.

Talking books may be produced with various sound effects on different pages (for example, pressure sensitive sound chips) or with a recording unit permanently attached to the book. If the book itself becomes worn, damaged, or is in a condition that requires discarding, the permanent recording unit is not transferable to another book. Accordingly, a need exists for a recording unit that may be transported to other locations apart from the book or other item, may be used for recording away from the book or other item, and/or may be reused in other books or items.

The present invention is to a securable recording unit that may be secured to a book or item by means of a plurality of attachments that may engage (e.g., by slideable engagement or a friction fit) the book or other item. The securable recording unit of the present invention may include an audio input means (e.g., a microphone) for receiving audible sounds (such as, but not limited to, voice, music, surf, water sounds, wind, nature sounds, etc.), a playback device for playing the audible sounds, and a storage unit for storing the received audible sounds. An example of the playback device may include a speaker, an amplifier, and/or any other similar, suitable, or conventional audio output means.

In one embodiment, the means for attaching the securable recording unit to a book may provide a flat, yet secure method of attaching the recording unit. For example, the recording unit may have at least one receptacle (e.g., at least one female connector) that is adapted to mate with at least one receiving unit (e.g., a male connector or plug) of the book. A receptacle of one embodiment of the recording unit may be keyhole shaped and may mate with a receiving unit of the book. For example, the attachments may be slideably engaged by placing a receiving unit of the book in a receptacle of the recording unit and then moving the recording unit relative to the book. A click may then be heard, and the recording unit is securably in place on the book. To remove the recording unit, the recording unit may be moved in the opposite direction to disengage the attachments. In an alternative embodiment of the present invention, the recording unit may have at least one male-type of connector that is adapted to engage a female-type of connector on the book or other item. In such an embodiment, the recording unit may be attached and removed in a similar manner as described above.

One embodiment of the present invention is a securable recording unit that may be attached to a book that is adapted to slideably receive the recording unit. A second embodiment of the present invention is a securable recording unit that may be attached to a photo album that is adapted to slideably receive the recording unit. In yet another embodiment, the present invention is a securable recording unit that may be attached to a scrapbook that is adapted to slideably receive the recording unit.

Any embodiment of the present invention may include any optional or preferred feature of any other embodiment of the present invention. In addition to the novel features and advantages mentioned above, other objects and advantages of the present invention will be readily apparent from the following descriptions of the drawings and exemplary embodiments.

### BRIEF DESCRIPTION OF THE DRAWINGS

FIG. 1 is a plan view of an exemplary embodiment of a securable recording unit of the present invention as attached to an exemplary scrapbook.

FIG. 2 is a plan view of exemplary receiving units of the scrapbook shown in FIG. 1 (the recording unit is not shown for clarity).

FIG. 3 is a plan view of the bottom of the securable recording unit shown in FIG. 1.

FIG. 4 is a plan view of the top of the securable recording unit shown in FIG. 1.

FIG. 5 is a side elevation view of the securable recording unit shown in FIG. 1.

### DETAILED DESCRIPTION OF EXEMPLARY EMBODIMENT(S)

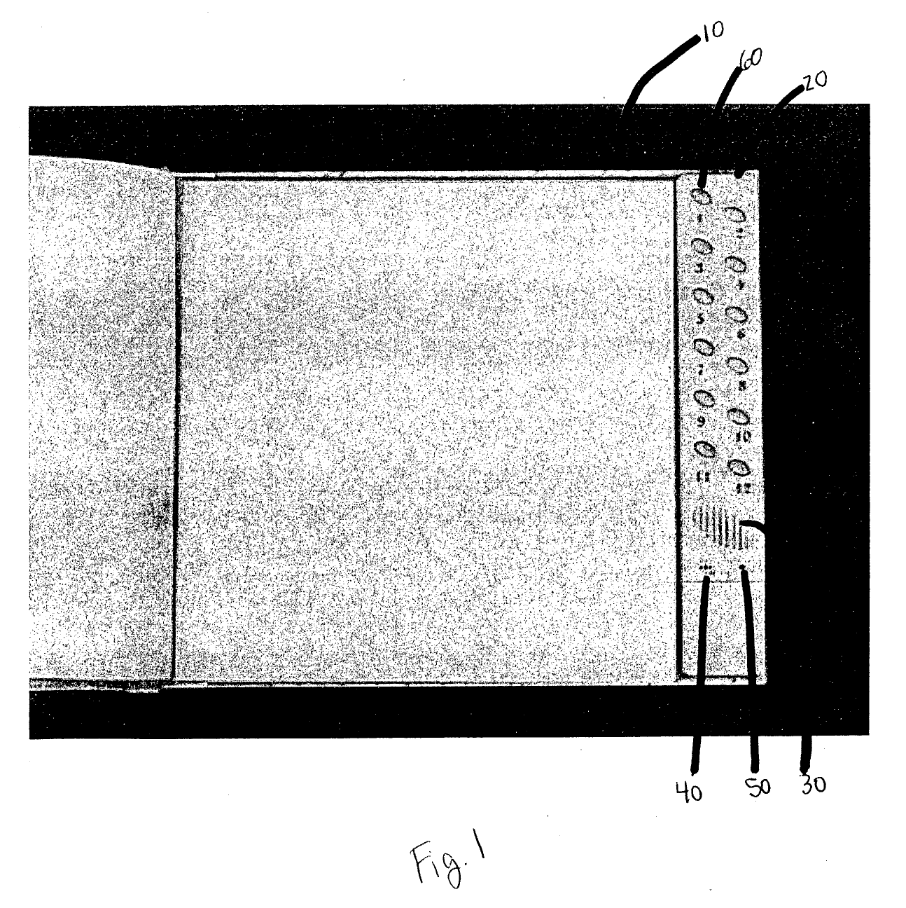

With reference now to the figures, there is depicted an embodiment of a securable recording unit 20 in FIG. 1 according to the principles disclosed by the present invention.

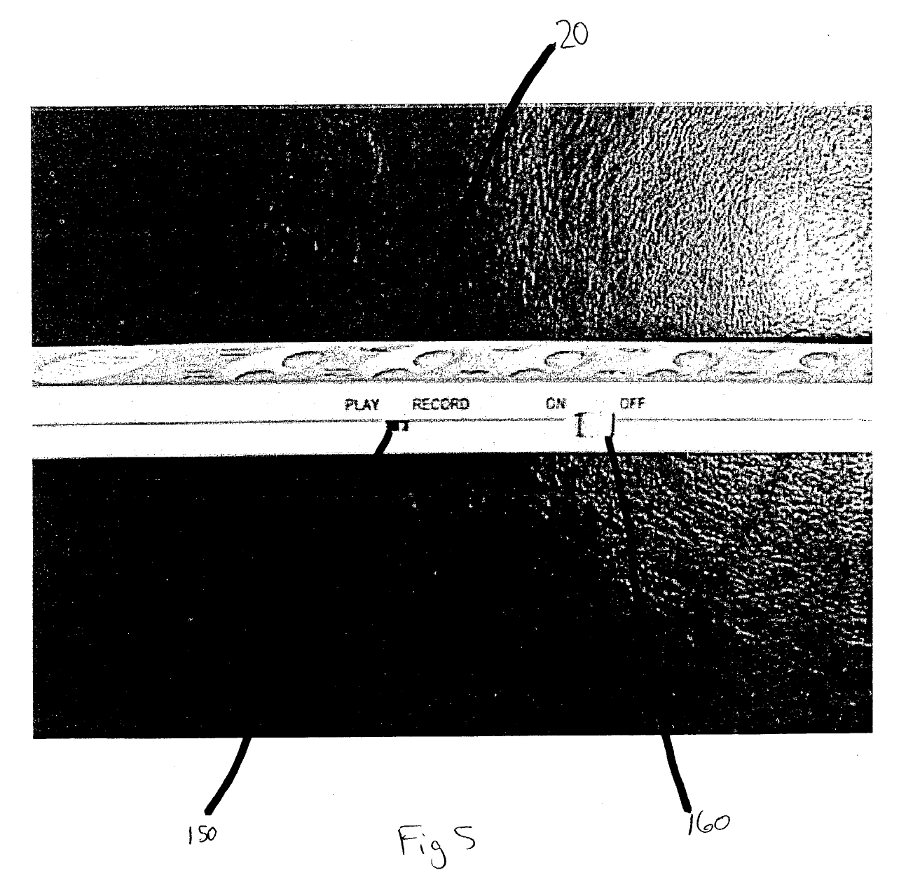

FIG. 1 shows a scrapbook 10 with a securable recording unit 20 in place and to the right of the pages of the scrapbook. In this embodiment, the securable recording unit 20 includes an audio input 40 means for receiving audible sounds and an audio output means 30 for playing back the audible sounds. Included may be an indicator light 50 for indicating when the recording unit is on, recording a sound, and/or playing back a sound. In one embodiment, when the light 50 is lit, the exemplary unit may be in a state for either playing back a pre-recorded sound or recording a sound, depending on the direction of the Play/Record button (as seen and described in FIG. 5). In another embodiment, the light 50 may be lit only when the unit 20 is actually recording a sound or playing a sound. For example, a user may press a button 60 when the unit 20 is in the record mode, and the light 50 will be lit for a predetermined period of time to indicate the amount of time that the unit 20 is actually recording. When the unit 20 is in the play mode, a user may press a button 60 to play a pre-recorded message. Each button 60 may be used to store and play a different sound, if desired. The scrapbook 10 may optionally have the same number of pages as buttons 60 on the securable recording unit 20. In other words, each button 60 may be dedicated to a respective page. Alternatively, a button 60 may be dedicated to more than one page in the scrapbook 10. Each button 60 may enable sounds to be recorded and played that correspond to a page or range of pages in the scrapbook 10. The recording unit 20 may include any suitable or conventional electronic circuitry and devices to perform the aforementioned functions.

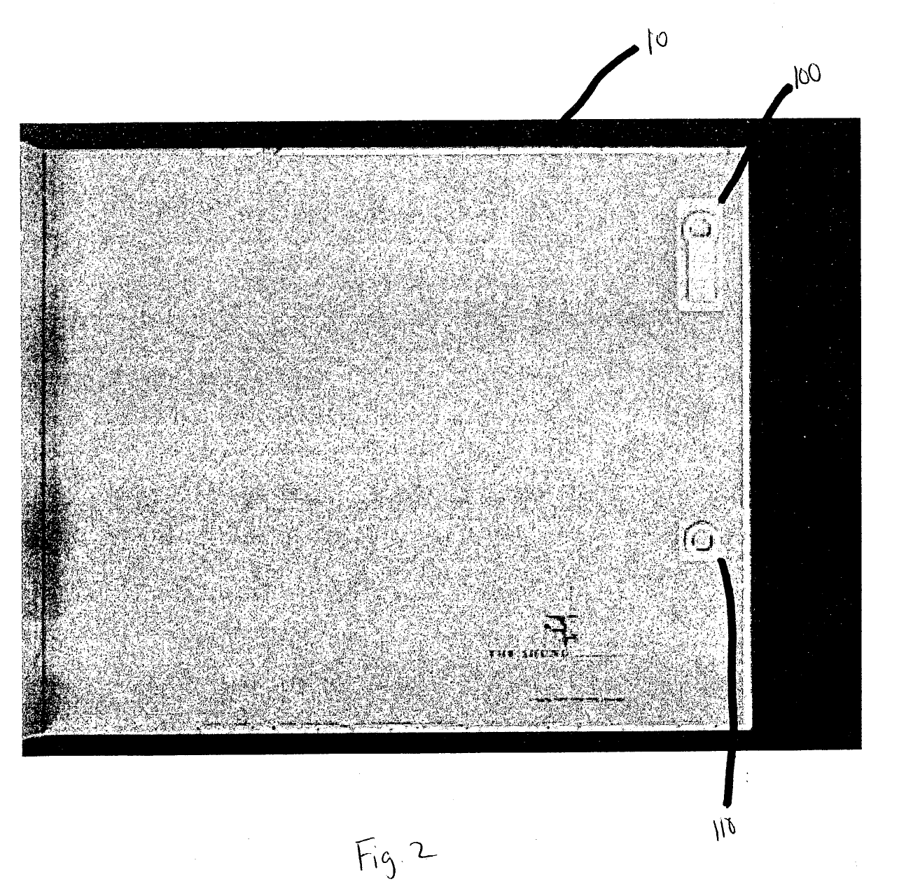

The scrapbook 10 may include at least one receiving unit for securing the recording unit 20. For example, FIG. 2 shows a plurality of receiving units 100 and 110 of the scrapbook 10. In this example, the receiving units 100 and 110 are raised projections that are secured to the scrapbook and are complementary units for receiving the securable recording unit 20. The rounded portions of the receiving units of this example include an outer flange or rim to facilitate an interlocking engagement with the corresponding receptacle of the securable recording unit. The securable recording unit fits onto the plurality of complementary receiving units 100 and 110 and slides down to removably attach to the scrapbook 10.

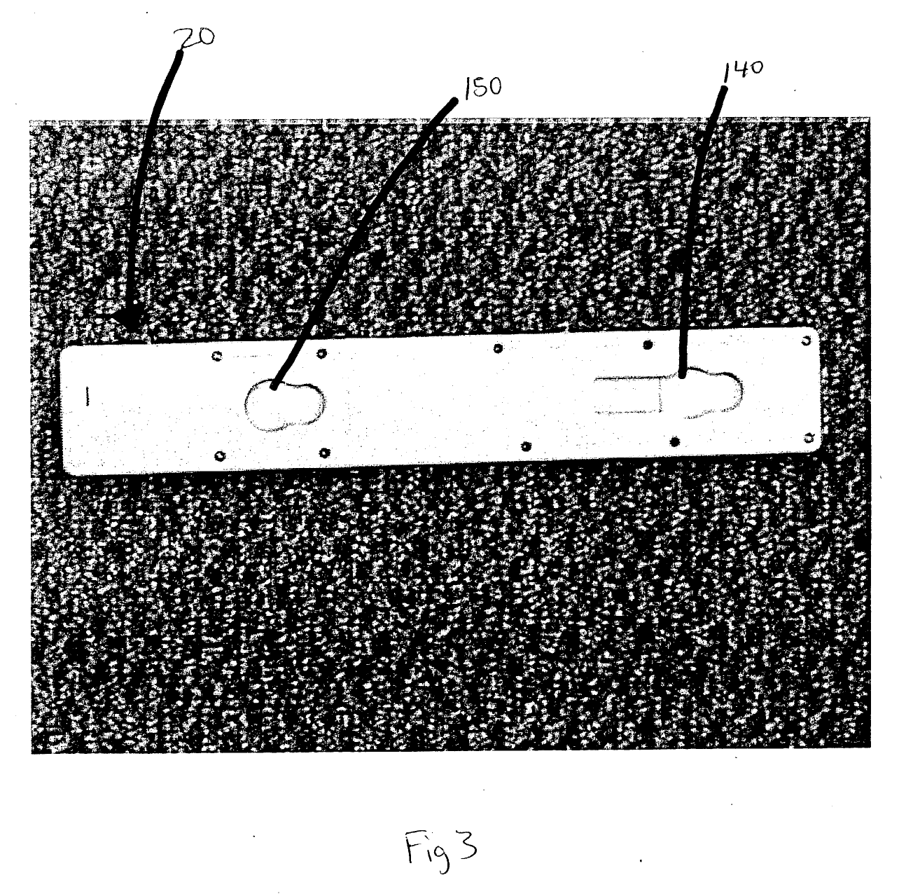

FIG. 3 shows the back side of the securable recording unit 20. The securable recording unit 20 may have a plurality of complementary receptacles 140 and 150 that are adapted to receive the receiving units 100 and 110, respectively. The securable recording unit 20 may be placed on the plurality of receiving units. The recording unit 20 may then be slid relative to the scrapbook 10 in order to obtain a desired fit between the receptacles and the receiving units. In particular, each of the receptacles of this example have recessed portions of suitable size and shape to receive the appropriate receiving unit of scrapbook. As the recording unit 20 is slid relative to the scrapbook 10 in this embodiment, a tighter, more secure fit is obtained between the receptacles and receiving units. Moreover, in this example, each of the recessed portions include an outer flange or rim to facilitate an interlocking engagement with the flange or rim of the corresponding receiving unit. If it is desired to remove or replace the recording unit 20, it may be slid in an opposite direction in this example in order to disengage the receptacles and receiving units.

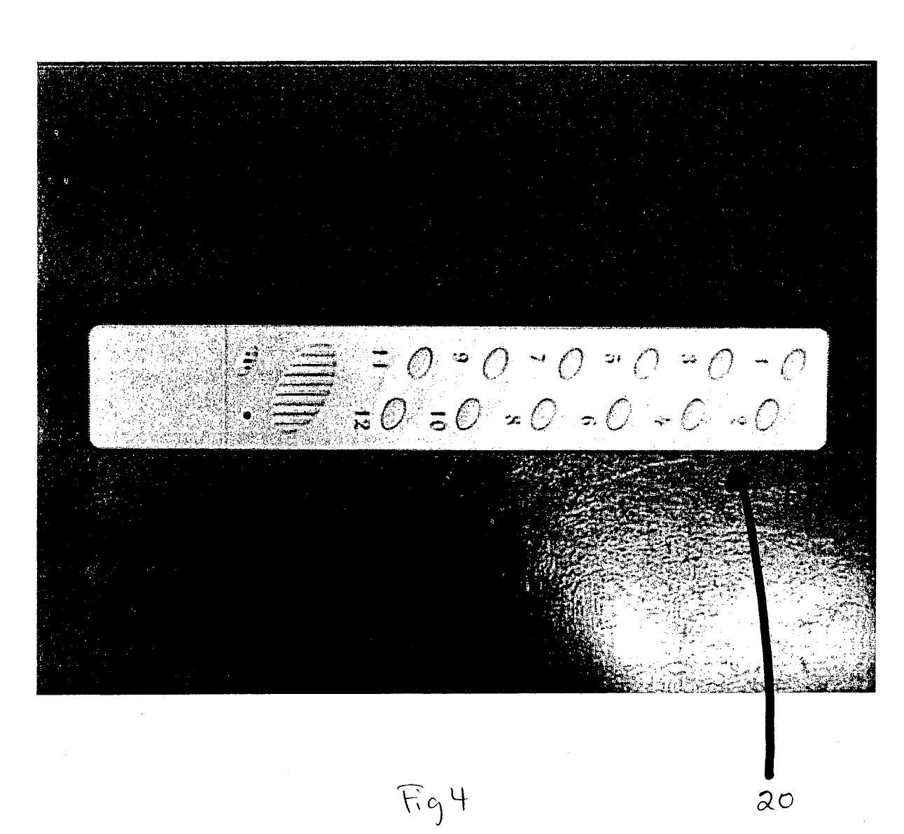

FIG. 4 shows a top plan view of the securable recording unit 20 of the present invention. All parts of FIG. 4 have been fully described in FIG. 1.

FIG. 5 shows a right side view of the securable recording unit 20 of the present invention. The securable recording unit 20 may include a button or switch 150 on the side for changing the mode from “play” to “record” and a button or switch 160 on the side for turning the securable recording unit 20 “on” or “off”. The Play/Record button 150 may be moved by means of a finger or sharp tipped object such as a pen or pencil tip. Once sounds are recorded on the securable recording unit 20, the button 150 may be positioned in the “play” position, and the sounds on the unit will not be recorded over inadvertently.

It should be recognized that the teaching provided herein is equally applicable to securing the recording unit to any desired item, not limited to a book, scrapbook, photo album, catalog, display, or wall. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. An electronic book comprising:
a securable recording unit having a plurality of receptacles for securably attaching to a book; and
a book having a plurality of complementary receiving units for engaging said securable recording unit.

2. The book of claim 1 wherein said book is a photo album.

3. The book of claim 1 wherein said book is a scrapbook.

4. The securable recording unit of claim 1 wherein said unit further comprises:
an audio input means for receiving audible sounds;
an audio output means for playing back said audible sounds; and
a storage device adapted to store said received audible sounds.

5. A method for recording personalized sounds associated with specific pages or page ranges in a detachable book, comprising the steps of:
providing a recording unit having at least one receptacle;
engaging said at least one receptacle of said recording unit with at least one receiving unit of said book;
engaging a switch on a side of a recording unit such that said recording unit has power;
engaging a switch on said side of a recording unit such that said recording unit is in a record mode;
pressing a button on a top of said recording unit;
speaking into a microphone on said top of said recording unit; and
recording sounds that correspond to said pages in said detachable book.
